(19) United States
(12) Patent Application Publication
(10) Pub. No.: US 2015/0382061 A1
(43) Pub. Date: Dec. 31, 2015

(54) SPOILER MITIGATION METHODS AND SYSTEMS

(71) Applicant: SLING MEDIA, INC., Foster City, CA (US)

(72) Inventors: Mark Kikuya Maisenbacher, Palo Alto, CA (US); Yash Suresh Shah, San Mateo, CA (US)

(21) Appl. No.: 14/319,543

(22) Filed: Jun. 30, 2014

(51) Int. Cl. H04N 21/454; H04N 21/482

(52) U.S. Cl. CPC H04N 21/4542; H04N 21/482

(57) ABSTRACT

Methods and systems are provided for mitigating spoilers when placeshifting content. One exemplary method involves identifying a filtering criterion based on a media program available for viewing on a client device via a network, obtaining, via the network, content for presentation on the client device, identifying a portion of the content corresponding to the media program using the filtering criterion, and inhibiting presentation of the identified portion of the content on the client device.

### TECHNICAL FIELD

The following description generally relates to reducing the likelihood of a user encountering spoilers relating to a particular media program.

### BACKGROUND

Media content can now be received from any number of different sources and stored in a personal or digital video recorder (DVR) or the like for viewing at a later time (“time shifting”). Live or recorded media content can also be “placeshifted” to allow viewing at remote locations away from the viewer's primary television set. With the proliferation of portable consumer electronic devices with display and network communication capabilities, viewers have more opportunities to placeshift content. However, viewers are also increasingly likely to encounter spoilers that might interfere with their enjoyment of media content. Accordingly, it is now desirable to provide a more satisfactory user experience by creating systems and methods for reducing the likelihood of a user inadvertently encountering spoilers related to media content the user intends to view or is otherwise likely to be interested in viewing. Other desirable features and characteristics may also become apparent from the subsequent detailed description and the appended claims, taken in conjunction with the accompanying drawings and this background section.

### BRIEF SUMMARY

According to various exemplary embodiments, systems, devices and methods are provided for mitigating spoilers when placeshifting content. One exemplary method involves identifying a filtering criterion based on a media program available for viewing on a client device via a network, obtaining, via the network, content for presentation on the client device, identifying a portion of the content corresponding to the media program using the filtering criterion, and inhibiting presentation of the identified portion of the content on the client device.

Another embodiment of a method for mitigating spoilers involves identifying a recorded media program available for placeshifting from a media device to a client device via a network, identifying a filtering criterion corresponding to the recorded media program, receiving, at the client device via the network, content for presentation on the client device, applying the filtering criterion to the received content using the filtering criterion to identify a portion of the received content matching the filtering criterion, and inhibiting presentation of the identified portion of the received content on the client device.

In another embodiment, a computer-readable medium comprises computer-executable instructions that, when executed by a processing system, cause the processing system to identify a media program available from a media device for viewing via a network, identify filtering criteria corresponding to the media program, receive, via the network, content for presentation, apply the filtering criteria to the received content to identify a portion of the received content that satisfies the filtering criteria, and interfere with presentation of the identified portion of the received content on a display device coupled to the processing system.

Various embodiments, aspects and other features are described in more detail below.

### BRIEF DESCRIPTION OF THE DRAWING FIGURES

Exemplary embodiments will hereinafter be described in conjunction with the following drawing figures, wherein like numerals denote like elements, and

FIG. 1 is a block diagram of a system for placeshifting content from a media device to a client device in accordance with one or more embodiments;

FIG. 2 is a flowchart of an exemplary spoiler mitigation process suitable for use with the placeshifting system of FIG. 1 in accordance with one or more embodiments;

FIG. 3 is a diagram illustrating a sequence of communications within the placeshifting system of FIG. 1 in accordance with one exemplary embodiment of the spoiler mitigation process of FIG. 2;

FIG. 4 is a diagram illustrating a sequence of communications within the placeshifting system of FIG. 1 in accordance with another exemplary embodiment of the spoiler mitigation process of FIG. 2;

FIG. 5 is a diagram illustrating a sequence of communications within the placeshifting system of FIG. 1 in accordance with another exemplary embodiment of the spoiler mitigation process of FIG. 2;

FIG. 6 is a diagram illustrating a sequence of communications within the placeshifting system of FIG. 1 in accordance with one exemplary embodiment of the spoiler mitigation process of FIG. 2;

FIG. 7 is a diagram illustrating a sequence of communications within the placeshifting system of FIG. 1 in accordance with one exemplary embodiment of the spoiler mitigation process of FIG. 2; and

FIG. 8 depicts an exemplary graphical user interface (GUI) display that may be presented on the client device in the placeshifting system of FIG. 1 in conjunction with the spoiler mitigation process of FIG. 2 in one or more embodiments.

### DETAILED DESCRIPTION

The following detailed description of the invention is merely exemplary in nature and is not intended to limit the invention or the application and uses of the invention. Furthermore, there is no intention to be bound by any theory presented in the preceding background, brief summary, or the following detailed description.

Embodiments of the subject matter described herein generally relate to reducing the likelihood of a user inadvertently encountering a spoiler with respect to a particular media program that the user likely intends to view or is otherwise likely to be interested in viewing, thereby mitigating the potential effect of the spoiler. As used herein, “media content,” “media program,” or variants thereof should be understood as referring to any audio, video, audio/visual or other programming in any streaming, file-based or other format. For purposes of explanation, the subject matter may be described herein in the context of recorded or live broadcast media programs available at a media device for placeshifting to a client device operated by the user. However, it should be appreciated that the subject matter described herein is not necessary limited to any particular type of media program or any particular type of content source.

In exemplary embodiments, a media program that is available for viewing on a client device from a media device via a network is identified as a media program about which the user would like to avoid encountering spoilers. Based on that identified media program, one or more filtering criterions are determined and applied to content received by the client device to detect or otherwise identify a potential spoiler within the received content. In this regard, the received content is parsed, scanned, or otherwise analyzed for portions that match or otherwise satisfy one or more of the filtering criterions implemented by the spoiler filter. In exemplary embodiments, the filtering criterion(s) corresponding to the identified media program are realized as one or more pieces (or fields) of metadata or other descriptive information associated with the identified media program, such as, for example, a primary title or series title of the media program, a secondary title or episode title of the media program, a program identifier associated with the media program, and/or other information that describes the content of the media program.

In response to identifying a portion of the received content that is likely to contain a spoiler with respect to the identified media program, one or more actions are performed to inhibit, impede, or otherwise interfere with the normal presentation of that identified portion. At the same time, the presentation of the remaining portions of the received content may be unaffected, thereby allowing the user to freely access or view to the remaining portions of the received content that are unlikely to contain spoilers. In one embodiment, the identified media program for which spoiler mitigation is implemented is a previously broadcast media program that is recorded or otherwise stored on the media device. In other embodiments, the identified media program for which spoiler mitigation is implemented may be a future broadcast media program that is scheduled to be recorded on the media device, a broadcast media program currently or previously streamed from the media device to the client device, or a broadcast media program manually identified by the user. It should be noted that in practice, the subject matter described herein may be implemented concurrently for multiple different media programs (e.g., for each of the media programs stored on the media device), with filtering criteria corresponding to multiple different media programs being applied to the received content. For example, the filtering criteria applied by the spoiler filter may be determined based on the recorded media programs on the media device in addition to any media programs scheduled for recording on the media device. Additionally, it should be noted that in practice, there are numerous different techniques which may be employed to inhibit or otherwise interfere with presentation of content, and the subject matter described herein is not intended to be limited to a particular technique for inhibiting presentation of content or a particular combination thereof.

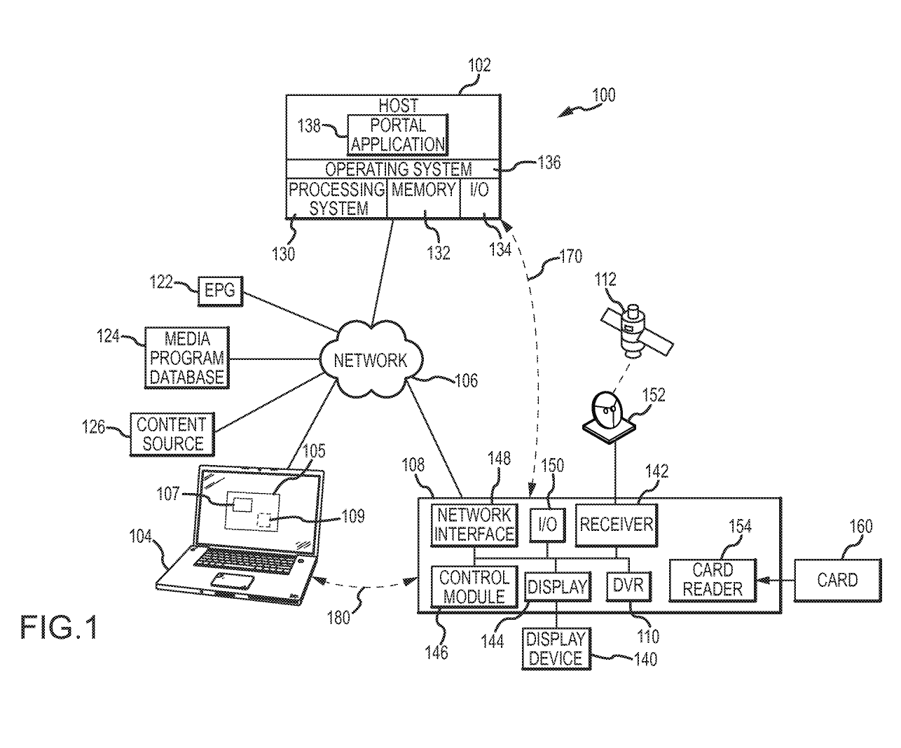

FIG. 1 depicts an exemplary embodiment of a system 100 for placeshifting or otherwise transferring data or content, such as a media program (or media content), from a source electronic device 108 to a destination electronic device 104 over a network 106 for presentation to a user (or viewer) on the destination electronic device 104. For purposes of explanation, but without limitation, the source device 108 may be alternatively referred to herein as a media device or a placeshifting device, and the destination electronic device 104 may be alternatively referred to herein as a playback device or a client device (or client). The placeshifting system 100 also includes a host server 102 (or host) that communicates or otherwise interacts with the devices 104, 108 over the network 106 to facilitate establishment of a peer-to-peer connection 180 over the network 106, which may be utilized for a placeshifting session, as described in greater detail below. It should be understood that FIG. 1 is a simplified representation of the placeshifting system 100 for purposes of explanation is not intended to limit the subject matter described herein in any way.

In practice, the client device 104 may be any device, component, module, hardware and/or the like that is capable of communicating with the server 102 over network 106. For example, depending on the embodiment, client device 104 may be realized as a conventional personal computer, portable computer, a tablet computer, workstation and/or other computing system, a mobile (or cellular) telephone, a smartphone, a personal digital assistant, a video game player, and/or any other device capable of receiving media programs via the network 106 and presenting audio and/or visual content. In this regard, the client device 104 includes a display device, such as a monitor, screen, or another conventional electronic display, capable of graphically presenting visual content, data and/or information that is generated or otherwise provided by an application 105, 107 executing on the client 104. The client device 104 may further include a user input device, such as a keyboard, a mouse, a touchscreen, or the like, capable of receiving input data and/or other information from the user of the client device 104. The client device 104 also includes a processing system and a data storage element (or memory) that is coupled to or otherwise accessed by the processing system and stores programming instructions that, when read and executed, cause the processing system of the client device 104 to generate one or more applications 105, 107, 109 executing thereon and perform various tasks, functions, processes and/or operations and support the subject matter described herein. The processing system may be realized as any sort of processor, microprocessor, microcontroller, digital signal processor, or any other suitable processing device, or any suitable combination thereof.

The client 104 may reside at a geographic location that is remote or otherwise physically distinct from the geographic location of the media device 108. In this regard, the media device 108 may have an essentially fixed or permanent geographic location, whereas the geographic location of the client 104 may be transient or otherwise variable with respect to the location of the media device 108. For example, the media device 108 may be realized as a set-top box or a similar device that resides at a user's home for providing media content to the user's television or other home display device 140, while the client 104 is realized as a portable electronic device, such as a mobile phone or other mobile computing device, that moves about with the user.

In the embodiment shown in FIG. 1, client device 104 executes any sort of conventional browser or other client application 105 that is compatible with standard Internet, world wide web (WWW), transmission control protocol and/or internet protocol (TCP/IP), and/or other formats. Such browsers are typically capable of displaying active or other documents formatted in accordance with published protocols (e.g., hypertext markup language (HTML), extensible markup language (XML), and/or the like). Many browsers are also capable of executing “plugin” applications, applets or the like. Such plugins may be formatted in accordance with ActiveX, JAVA and/or any number of other formats. A number of commonly used web browsers are available for a number of different computing platforms, and the subject matter described herein is not limited to any particular browser application. In the illustrated embodiment, client 104 further includes a media player application 107. The media player 107 may be a standalone media player, or the media player 107 may be implemented as a plugin or other applet that runs within the client application 105 as desired. In some embodiments, media player 107 is initially obtained from a networked host, such as server 102. The media player 107 may be retrieved on an as-needed basis in some embodiments, or may be stored at client 104 for subsequent execution.

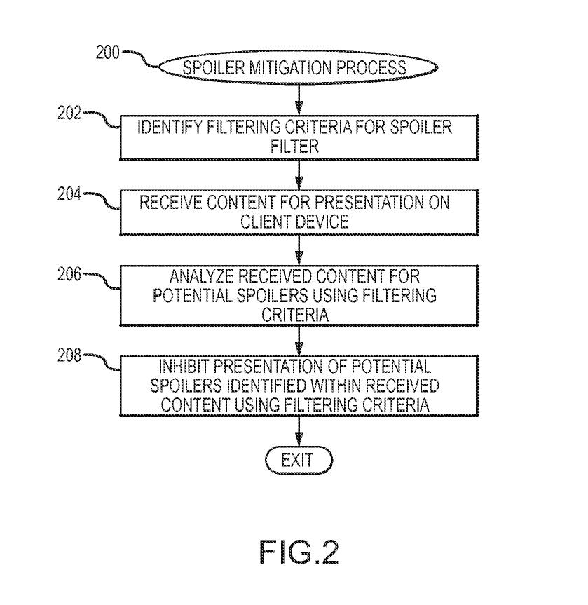

As described in greater detail below in the context of FIGS. 2-6, in exemplary embodiments, the client device 104 also includes or otherwise executes a content filtering application 109 that facilitates inhibiting presentation of potential spoilers on the client 104 with respect to one or more media programs that the user of the client 104 likely intends to view. The content filtering application 109 identifies or otherwise determines one or more filtering criterions that are to be applied to content received by the client device 104 via the network 106 to detect or otherwise identify spoilers within the received content. In one or more embodiments, the filtering criteria corresponds or otherwise relates to one or more media programs that are or will be available for viewing at the media device 108 and/or on the client device 104 (e.g., from the media device 108 via the network 106) which the user of the client 104 likely intends to view. In this regard, the filtering criteria are utilized by the content filtering application 109 to detect or otherwise identify received content (or portions thereof) that may contain potential spoilers with respect to the media program(s) that are or will be available for viewing by the user. In exemplary embodiments, the content filtering application 109 applies the filtering criteria to content received by the client device 104 via the network 106 prior to the received content being presented on the client device 104. The content filtering application 109 disrupts, inhibits, or otherwise interferes with the normal presentation of portions of the received content that match or otherwise satisfy at least one of the filtering criterions, thereby reducing the likelihood of the user of the client device 104 inadvertently encountering spoilers when the received content is presented on the client device 104. Accordingly, for purposes of explanation, but without limitation, the content filtering application 109 may alternatively be referred to herein as a spoiler filter.

In one or more exemplary embodiments, the content filtering application 109 is realized as a plug-in or other applet that is integrated into or otherwise runs within the client application 105. In alternative embodiments, the content filtering application 109 may be realized as a standalone application or background process executing on the client device 104 independently of the client application 105. In one or more exemplary embodiments, the content filtering application 109 is downloaded or otherwise obtained from the network 106. For example, the client device 104 may download, retrieve, or otherwise obtain programming instructions corresponding to the content filtering application 109 from the server 102 and store the instructions in the data storage element (or memory) associated with the client device 104. Thereafter, the processing system of the client device 104 reads and executes the programming instructions to generate or otherwise provide the content filtering application 109 on the client device 104. In some embodiments, where the content filtering application 109 is realized as a plugin, the programming instructions corresponding to the content filtering application 109 may be integrated with the programming instructions corresponding to the client application 105, such that the content filtering application 109 is automatically generated within the client application 105 when the processing system of the computing device 104 reads and executes the programming instructions for generating the client application 105.

Still referring to FIG. 1, in exemplary embodiments, the media device 108 is any device, module, component, hardware and/or the like capable of receiving and processing media content from one or more content sources. For example, in some embodiments, media device 108 is a set-top box (STB) or similar system that is able to receive television programming and/or to record certain programs that can be viewed on a display device 140, such as a television, monitor, liquid crystal display (LCD), light emitting diode (LED) display, plasma display, or the like. Exemplary embodiments of media device 108 will therefore include or otherwise be coupled to a receiver interface 142 for receiving satellite, cable and/or broadcast programming signals from broadcast sources 112, as well as a data storage medium 110 (e.g., a hard disk, flash memory, or another suitable non-volatile data storage element) to support a digital video recorder (DVR) feature and/or functionality, a display interface 144 for providing imagery to the display device 140, and a control module 146 that directs the operations of the media device 108 as appropriate. For convenience, but without limitation, the data storage medium 110 is alternatively referred to herein as a DVR. Media device 108 may also include one or more interfaces 148 to the network 106 and/or an input/output interface 150 to a remote control or other device for providing user inputs to the media device 108, as appropriate. For example, the network interface(s) 148 of the media device 108 may include an interface or port for a wired communications layer (e.g., an Ethernet port or adapter), an interface for a wireless communications layer (e.g., an IEEE 802.11-compatible transceiver), and/or the like.

The components in media device 108 may be provided within a common chassis or housing as depicted in FIG. 1, although equivalent embodiments may implement media device 108 with any number of inter-connected but discrete components or systems. For example, in some embodiments, the media device 108 may be realized as a combination of a STB and a placeshifting device, wherein some features of the media device 108 (e.g., the DVR 110, the receiver 142, the display interface 144, and/or I/Os 150) are implemented by the STB and other features of the media device 108 (e.g., the network interface 148) are implemented by the placeshifting device, wherein the placeshifting device works in conjunction with the STB to shift the viewing experience from a home television (e.g., display device 140) to a viewing display on the client device 104 that is accessed via the network 106. Examples of placeshifting devices that may be used in some embodiments of media device 108 could include any of the various SLINGBOX products available from Sling Media of Foster City, Calif., although other products or servers could be used in other embodiments. Many different types of placeshifting devices are generally capable of receiving media content from an external source, such as any sort of DVR or STB, cable or satellite programming source, DVD player, and/or the like. In other embodiments, placeshifting features are incorporated within the same device that provides content-receiving or other capabilities. Media device 108 may be a hybrid DVR and/or receiver, for example, that also provides transcoding and placeshifting features. It should be appreciated that FIG. 1 depicts merely one exemplary embodiment of a media device 108, and in practice, the media device 108 may be logically and physically implemented in any manner to suit the needs of a particular embodiment.

In the exemplary embodiment illustrated in FIG. 1, media device 108 is capable of receiving digital broadcast satellite (DBS) signals transmitted from a broadcast source 112, such as a satellite, using an antenna 152 that provides received signals to the receiver 142. Equivalent embodiments, however, could receive programming at receiver 142 from any sort of cable connection, broadcast source, removable media, network service, external device and/or the like. In some embodiments, the media device 108 may also include an access card interface or card reader 154 adapted to receive an access card 160 (or viewing card) configured to ensure that the viewer is authorized to view media content provided to the primary display device 140. In this regard, the access card 160 includes unique identification information associated with a particular subscriber to the broadcast content source 112 or otherwise includes subscription information that facilitates receiving and/or decoding media content provided by the broadcast content source 112.

The DVR 110 feature stores recorded programming (e.g., recorded broadcast programming received via receiver 142) on a hard disk drive, memory, a networked server, or other storage medium as appropriate in response to user/viewer programming instructions, wherein the recorded programming may be subsequently viewed via the media device 108, either on display device 140 or client device 104 via network 106. Content stored in DVR 110 may be any sort of file-based programming or other content that is accessible to media device 108. In various embodiments, in addition to storing broadcast programming, the DVR 110 may also store programming received from other sources not illustrated in FIG. 1, such as, for example, programming downloaded from an on-demand programming source or an online programming source. Additionally, content in DVR 110 may be stored in any sort of compressed or uncompressed format, as desired, and may be encoded or transcoded as desired for effective receipt, storage, retrieval and playing.

The control module 146 is any sort of hardware, circuitry, processing logic and/or other components capable of directing the operations of media device 108. In various embodiments, control module 146 includes software or firmware logic and/or other programming instructions residing in memory and executing on any sort of processing system, such as any sort of processor, microprocessor, microcontroller, digital signal processor or the like. The instructions, when read and executed, cause the control module 146 to perform various tasks, functions, processes and/or operations and otherwise support the subject matter described herein. In various embodiments, the control module 146 is based upon a “system on a chip” (SoC) implementation that incorporates a hybrid microcontroller with memory, input/output and other features to perform the various signal processing and other actions of media device 108. Other embodiments may implement control module 146 and/or the other features of media device 108 with any number of discrete and/or integrated processing components (e.g., any sort of microprocessor or microcontroller), memories, input/output features and/or other features as desired. The control module 146 communicates with the network interface 148 to establish a peer-to-peer connection 180 to the client device 104 over the network 106 and support streaming of media programs (e.g., from the DVR 110 or the receiver 142) to the client device 104 over the network 106 via the peer-to-peer connection 180, as described in greater detail below.

In the embodiment of FIG. 1, the network 106 is any communications network (or a combination of communications networks) capable of transmitting data between devices within the system 100. In various embodiments, network 106 includes any number of public or private data connections, links or networks supporting any number of communications protocols. Network 106 may include the Internet, for example, or any other network. Such networks may be based upon TCP/IP or other conventional protocols, although other embodiments may use any type of alternate or successor protocols, as desired. In various embodiments, network 106 may also incorporate a wireless and/or wired telephone network, such as a cellular communications network for communicating with mobile phones, personal digital assistants, and/or the like. Various embodiments of network 106 may also incorporate any sort of wireless or wired local area networks (LANs), wide area networks (WAN), or the like.

In the illustrated embodiment of FIG. 1, the server 102 may be realized as one or more server computers or other device(s) coupled to the network 106 and capable of interacting with the devices 104, 108 to facilitate communications between the client device 104 and the media device 108 associated with the user or operator of the client 104. The server 102 may be implemented with a server computer system or data processing system that is based upon any processor, architecture and/or operating system, and will typically be implemented using any sort of processing system 130, memory 132 and input/output features 134. Various embodiments may be implemented using dedicated or shared hardware servers; other implementations may make use of virtual server features as part of a “cloud computing” service, such as any of the cloud computing services provided by any number of providers. Although FIG. 1 shows a single server 102 for convenience, many practical embodiments of the system 100 may provide a cluster or other collection of multiple host servers 102 to support any desired number of simultaneous communications with multiple clients 104 and/or multiple media devices 108. This cluster may also incorporate appropriate routing, load balancing, access and security mechanisms and or any number of other features. In various embodiments, each server 102 is an actual or virtual computer system executing an operating system 136 in conjunction with the processing system 130, memory 132 and/or I/O features 134 to provide a computing core that is capable of executing a portal application 138, as well as any number of daemons, processes, applications or other modules as desired. For example, a portal application 138 could execute as a daemon on the server 102, with connections to separate clients 104 being managed as separate processes or instances that communicate with portal application 138 using features provided by operating system 136. In one or more embodiments, the memory 132 stores programming instructions that, when read and executed, cause the processing system 130 to create, generate, or otherwise facilitate the portal application 138 and perform various tasks, functions, processes and/or operations described herein. In this regard, the memory 132 represents any non-transitory short or long term data storage element or other computer-readable media capable of storing programming instructions for execution by or on the processing system 130.

The user of the client 104 is able to connect to the portal application 138 supported by host 102 via the network 106, for example, by directing the client application 105 to a URL or other network address associated with host 102 and/or portal application 138. In exemplary embodiments, after the user is successfully authenticated by the portal application 138, the host 102 and/or portal application 138 establishes a connection 170 over the network 106 to the media device 108 that is associated with the user. Thereafter, the host 102 and/or the portal application 138 utilizes the connection 170 to obtain, from the media device 108 via the network 106, information about programming stored at the media device 108 and available for placeshifting to the client device 104, such as, for example, a listing of the media programs stored on DVR 110. It should be noted that although FIG. 1 depicts the network connection 170 as being between the host 102 and the media device 108, in practice, the placeshifting system 700 may include one or more intermediary components (e.g., one or more message servers) configured to establish, facilitate, or otherwise support the connection 170.

As described in greater detail below, in some embodiments, the spoiler filter 109 obtains the listing of media programs stored on the DVR 110 from the host 102 and/or the portal application 138 and utilizes the listing of media programs stored on the DVR 110 to identify or otherwise determine filtering criteria. In turn, the filtering criteria are used to inhibit presentation of content on the client device 104 that relates to or is otherwise likely to contain potential spoilers with respect to one or more of the stored media programs on the DVR 110. Additionally, in some embodiments, the host 102 and/or the portal application 138 also obtain, from the media device 108, information about scheduled recordings on the media device 108, where the spoiler filter 109 utilizes the media programs scheduled for recording to the DVR 110 to identify or otherwise determine additional filtering criteria used to inhibit presentation of content on the client device 104 that relates to one or more of the media programs scheduled for recording on the DVR 110.

In one or more embodiments, the spoiler filter 109 limits, restricts, or otherwise interferes with the presentation of content received from one or more third-party content sources 126 within the placeshifting system 100, such as, for example, a web server, a website, an email server, and/or another similar content source accessible to the client device 104 and/or the client application 105 via the network 106. In this regard, content received from a third-party content source 126 that does not match or otherwise satisfy the filtering criteria implemented by the spoiler filter 109 may be presented without interference by the spoiler filter 109, whereas presentation of the portions of the received content identified as potentially containing spoilers may be influenced by the spoiler filter 109 in a manner that mitigates their potential effects on the user.

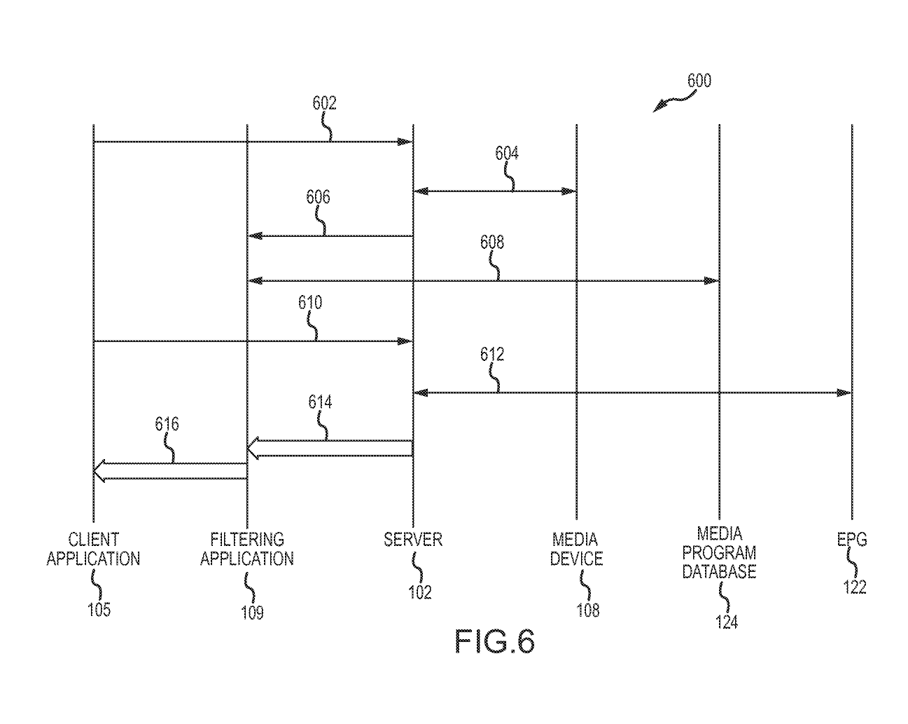

As described in greater detail below in the context of FIG. 6, in one or more exemplary embodiments, the server 102 is coupled to an electronic program guide 122, which may be realized as a server, a database, or another device operating on the network 106 that maintains information pertaining to current and/or future broadcasts (or airings) of media programs that are available to be received from broadcast source 112 (e.g., by the media device 108 via receiver 142 and/or antenna 152). The server 102 and/or the portal application 138 may obtain information pertaining to current and/or future broadcasts (or airings) of media programs from the electronic program guide 122 and generate or otherwise provide a program guide graphical user interface (GUI) display on the client device 104 (e.g., within client application 105) that indicates media programs that are or will be available for streaming from the media device 108. The user of the client device 104 may manipulate or otherwise utilize the graphical user interface (or the graphical user interface elements contained therein) to select or otherwise identify media programs for streaming to the client device 104 and/or recording to the DVR 110. As described in greater detail below, in one or more embodiments, the spoiler filter 109 analyzes content received from the server 102 and/or the portal application 138 corresponding to the program guide GUI to detect or otherwise identify media programs or other information contained therein that may contain potential spoilers. Thereafter, the spoiler filter 109 modifies, mitigates, or otherwise interferes with the normal presentation of those media programs or other information to reduce the likelihood of the user of the client device 104 inadvertently encountering spoilers when using the program guide GUI to select a broadcast media program for streaming from the broadcast source 112 to the client device 104 via the media device 108.

In the illustrated embodiment of FIG. 1, the placeshifting system 100 also includes a media program database 124 that includes verified or validated metadata and/or other descriptive information for a vast array of media programs. For example, the media program database 124 may contain metadata and/or other descriptive information pertaining to substantially all of the media programs that may be available from one or more content sources within placeshifting system 100 (e.g., information pertaining to any media programs that have previously been aired by a broadcast source 112, along information pertaining to any movie that has been presented in theaters, made available on-demand, or released for individual use (e.g., on digital video disc (DVD) or the like)). In exemplary embodiments, for each media program having a record (or entry) in the media program database 124, the media program database 124 maintains a media data object that includes one or more fields of metadata associated with that media program along with one or more fields of program identifiers that may be used to identify that media program record. In this regard, the program guide 122 and the media program database 124 may utilize the same program identifiers to uniquely identify each media program. As described in greater detail below in the context of FIGS. 2, 5 and 6, in some embodiments, one or more fields of metadata associated with a particular media program that is available for viewing on the client device 104 via the media device 108 may be utilized by the spoiler filter 109 to identify or otherwise determine additional filtering criteria used to inhibit presentation of content on the client device 104.

FIG. 2 depicts an exemplary embodiment of a spoiler mitigation process 200 suitable for implementation by a server in a placeshifting system, such as the server 102 in the system 100 of FIG. 1, to reduce the likelihood of a user inadvertently encountering spoilers with respect to one or more media programs that the user likely intends to view. The various tasks performed in connection with the illustrated process 200 may be implemented using hardware, firmware, software executed by processing circuitry, or any combination thereof. For illustrative purposes, the following description may refer to elements mentioned above in connection with FIG. 1. In practice, portions of the spoiler mitigation process 200 may be performed by different elements of the system 100, such as, for example, the server 102, the client device 104, the client application 105, the content filtering application 109, and/or the media device 108. It should be appreciated that the spoiler mitigation process 200 may include any number of additional or alternative tasks, the tasks need not be performed in the illustrated order and/or the tasks may be performed concurrently, and/or the spoiler mitigation process 200 may be incorporated into a more comprehensive procedure or process having additional functionality not described in detail herein. Moreover, one or more of the tasks shown and described in the context of FIG. 2 could be omitted from a practical embodiment of the spoiler mitigation process 200 as long as the intended overall functionality remains intact.

Referring to FIG. 2, and with continued reference to FIG. 1, the spoiler mitigation process 200 is performed after the content filtering application 109 is installed or otherwise instantiated on the client device 104 (e.g., by the user of the client device 104 downloading and installing the content filtering application 109 from the server 102). In the illustrated embodiment, the spoiler mitigation process 200 begins by identifying or otherwise determining filtering criteria to be utilized for identifying potential spoilers within subsequently received content (task 202). As described above, the content filtering application 109 that identifies or otherwise determines one or more filtering criterions pertaining to one or more media programs that the user likely intends to view or is otherwise likely to be interested in viewing, which may be media programs currently available for viewing on the client device 104 (e.g., from the media device 108 and/or DVR 110 via the network 106). In this regard, the filtering criteria may include or otherwise be realized as one or more pieces of metadata or other descriptive information associated with a particular media program, such as, for example, the primary title or series title of the media program, a secondary title or episode title of the media program, one or more fields of program identifiers associated with the media program, and/or other information that describes the content of the media program. In one or more exemplary embodiments, the filtering criteria are stored or otherwise maintained by the spoiler filter 109 on the client device 104 (e.g., in a data storage element or memory associated with the client device 104). In alternative embodiments, the filtering criteria are stored or otherwise maintained by the server 102 (e.g., in memory 132, a database coupled to the server 102, or the like) in association with the user of the client device 104 and downloaded or otherwise obtained by the spoiler filter 109 from the server 102 upon the portal application 138 authenticating the user of the client device 104.

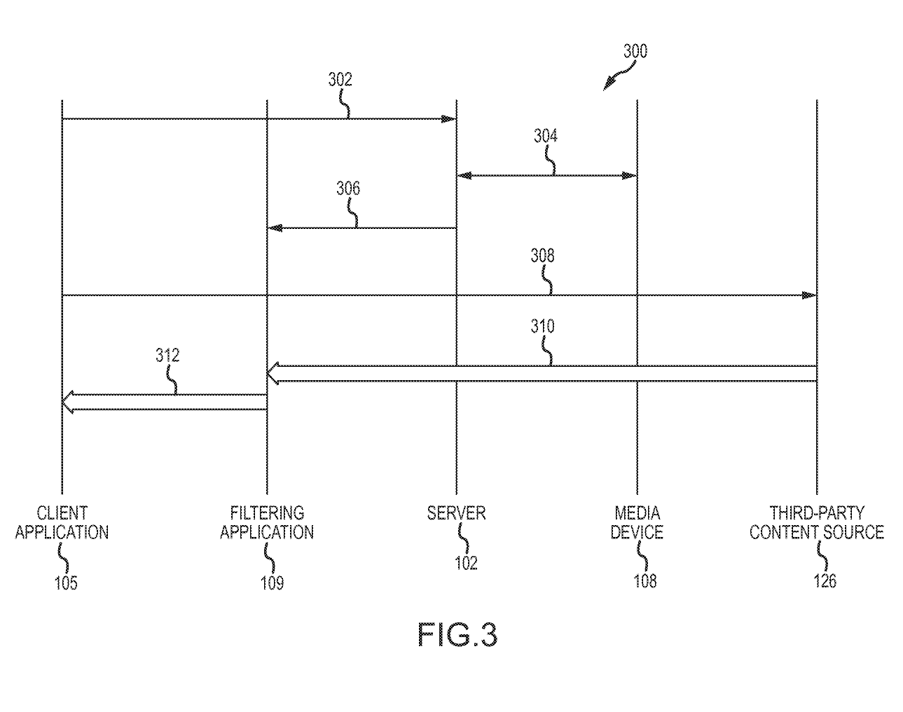

As described in greater detail below in the context of FIG. 3, in accordance with one or more embodiments, the filtering criteria for the spoiler filter 109 are automatically identified based on the media programs stored on the DVR 110 of the media device 108 associated with the user of the client 104. In other words, it may be assumed that the user likely intends to view a recorded media program on the DVR 110, therefore, the spoiler filter 109 may automatically determine filtering criteria corresponding to the recorded media program to avoid the user inadvertently encountering spoilers pertaining to that recorded media program. For example, after authenticating the user, the server 102 and/or the portal application 138 may contact the media device 108 associated with the user via the network 106 and download or otherwise obtain, from the media device 108 (e.g., via connection 170), a listing of the media programs stored on DVR 110. The listing provided by the media device 108 may include metadata that describes or otherwise identifies the recorded media programs on the DVR 110, such as, for example, program identifiers, titles, and/or other descriptive information. The spoiler filter 109 may download or otherwise obtain the listing of the recorded media programs on the DVR 110 from the server 102 and/or the portal application 138 via the network 106 and configure the filtering criteria based on the metadata associated with the recorded media programs. For example, for a particular recorded media program, the spoiler filter 109 may utilize the primary (or series) title, the episode title or number, air date, or the like associated with that recorded media program as one or more filtering criterions used to reduce the likelihood of the user encountering spoilers or information pertaining to that episode (or subsequent episodes) for that series.

In one or more embodiments, the spoiler filter 109 may also obtain supplemental metadata from the media program database 124 for use as one or more filtering criterions. For example, using one or more program identifiers associated with a particular recorded media program, the spoiler filter 109 may contact the media program database 124 via the network 106 to download or otherwise obtain one or more additional pieces (or fields) of metadata associated with that particular recorded media program for use as filtering criteria. Alternatively, the server 102 and/or the portal application 138 may contact the media program database 124 via the network 106 to obtain supplemental metadata, which, in turn, is provided to the spoiler filter 109 in conjunction with the listing of recorded media programs on the DVR 110.

In one or more embodiments, the filtering criteria for the spoiler filter 109 may also be automatically identified based on media programs scheduled for recording on the DVR 110 of the media device 108 associated with the user of the client 104. For example, the server 102 and/or the portal application 138 may also download or otherwise obtain, from the media device 108, a listing of the media programs scheduled for recording on DVR 110. In a similar manner as described above, the spoiler filter 109 may utilize the metadata associated with the scheduled recordings to configure the filtering criteria.

Still referring to FIG. 2, in some embodiments, the filtering criteria for the spoiler filter 109 may also be identified in response to receiving input from a user indicative of the media program(s) for which the user would like to avoid encountering spoilers. For example, the spoiler filter 109 may generate or otherwise provide a graphical user interface (e.g., within the client application 105 or independently of the client application 105) that includes one or more graphical user interface elements that are manipulatable by the user to indicate or otherwise identify media programs the user intends to view. In this manner, the user of the client device 104 may manually input the primary title, series title, episode title and/or number, and/or other information pertaining to media programs for which the user would like to avoid encountering spoilers. In some embodiments, the spoiler filter 109 may utilize the manual input information received from the user as the only filtering criteria. In alternative embodiments, the spoiler filter 109 may also obtain supplemental metadata from the media program database 124 for use as filtering criteria in addition to or in alternative to using the manually input information. For example, the spoiler filter 109 may utilize the manually input information for a particular media program as search criteria for searching the media program database 124 to identify an entry in the media program database 124 that best matches the information received by the user, and then utilize one or more fields of metadata for the matching entry in the media program database 124 as filtering criteria for the manually identified media program.

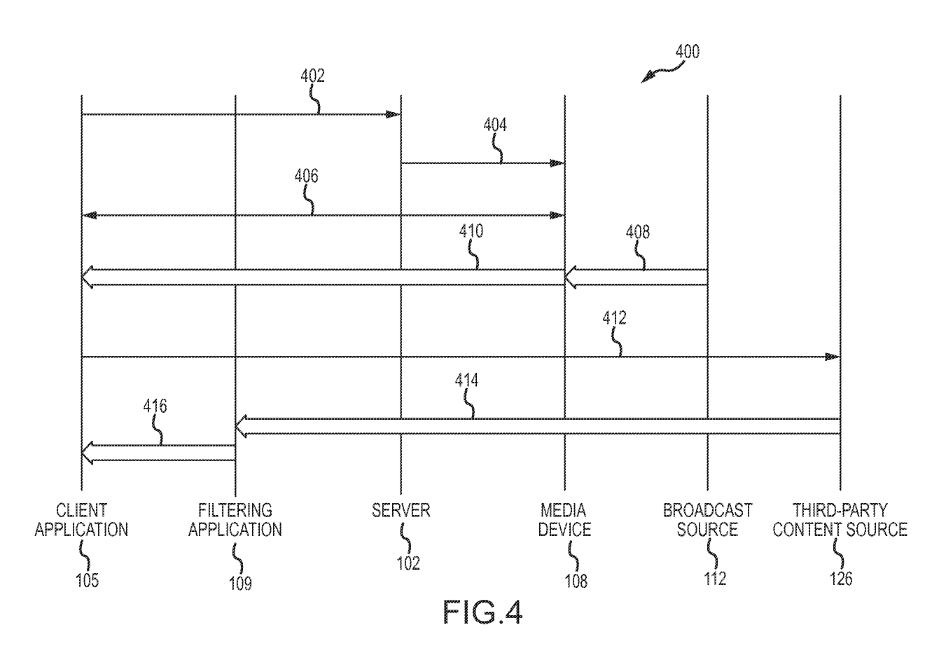

As described in greater detail below in the context of FIG. 4, in one or more embodiments, the spoiler filter 109 may also automatically identify or otherwise determine filtering criteria based on a media program currently being streamed from the media device 108 to the client device 104. For example, the peer-to-peer connection 180 may be established over the network 106 between the client device 104 and the media device 108 and a broadcast media program may be streamed by the media device 108 from the broadcast content source 112 to the media player application 107 via the peer-to-peer connection 180. In this regard, the spoiler filter 109 may identify or otherwise obtain, from the client application 105 and/or the media player application 107, one or more program identifiers or other metadata associated with the broadcast media program being streamed to the client device 104. Thereafter, the spoiler filter 109 may utilize the metadata associated with the streamed media program as filtering criteria to reduce the likelihood of the user encountering spoilers pertaining to that media program. In this manner, if the user pauses the streamed media program within the media player 107 and manipulates the client application 105 to contact a third-party content source 126 (e.g., for information pertaining to the streamed media program, general web browsing, to check email, or the like), the spoiler filter 109 may interfere with the presentation of portions of content from the third-party content source 126 related to the media program currently being streamed to the client device 104. For example, if the user manipulates the client application 105 to access a third-party website 126 for information about the media program currently being streamed, the spoiler filter 109 may interfere with the presentation of portions of content from the third-party website 126 that might pertain to subsequent portions of the media program that the user has not viewed. For example, portions of the received content pertaining to a current episode being viewed by the user and/or any subsequent episodes of that same series may be identified and presentation thereof inhibited based on the air date, episode title, and other filtering criteria associated with the episode currently being viewed. Thus, the user may obtain information from one or more third-party sources 126 and then resume viewing the streamed media program with a reduced likelihood of encountering information from the third-party source(s) 126 that would otherwise interfere with the user's enjoyment of the media program currently being streamed.

Still referring to FIG. 2, after the filtering criteria for the spoiler filter have been identified, the spoiler mitigation process 200 continues by receiving or otherwise obtaining content for presentation on the client device, parsing or otherwise analyzing the received content for potential spoilers using the identified filtering criteria, and inhibiting or otherwise interfering with the presentation of any potential spoilers that are identified within the received content based on the filtering criteria (tasks 204, 206, 208). In this regard, the spoiler filter 109 effectively functions as an intermediary between the client application 105 and/or the media player application 107 and the network 106, and the spoiler filter 109 parses, scans, or otherwise searches received content intended for presentation by the client application 105 and/or the media player application 107 for portions of the received content that match, satisfy, or otherwise correspond to one or more filtering criterions being implemented by the spoiler filter 109.

When the spoiler filter 109 identifies a portion of the received content that is likely to include a potential spoiler with respect to a particular media program based on the filtering criterion corresponding to that particular media program, the spoiler filter 109 initiates one or more remedial actions with respect to presenting the identified portion of the received content on the client device 104. For example, in one embodiment, the spoiler filter 109 may generate or otherwise provide a notification on the client device 104 (e.g., a pop-up window or another similar graphical user interface) that identifies the received content contains a potential spoiler with respect to a particular media program. In this regard, the user may respond to the notification by providing an indication that the user would like to proceed with presentation of the received content on the client device 104 (e.g., by manipulating a graphical user interface element associated with the notification). In response to receiving an indication that the user would like to proceed with viewing the received content, the spoiler filter 109 may provide the received content in an unaltered form to the client application 105 and/or the media player application 107 for presentation on the client device 104.

In another embodiment, the spoiler filter 109 may alter or otherwise modify the portion(s) of the received content that is likely to include a spoiler with respect to a particular media program before providing the received content in an altered form to the client application 105 and/or the media player application 107 for presentation on the client device 104. For example, if the received content corresponds to a webpage downloaded from a third-party web server 126, the spoiler filter 109 may parse or otherwise analyze the code for the webpage to identify portions of the webpage that match or otherwise satisfy one or more filtering criterions. After identifying potential spoilers within the webpage, the spoiler filter 109 may modify or otherwise alter the code for the webpage before providing the modified code for the webpage to the client application 105 for presentation on the client device 104. For example, for text within a webpage that was identified as a potential spoiler, the spoiler filter 109 may remove or delete the text from within the webpage, modify the visibility of the text within the webpage (e.g., by setting a background or fill for the text to be the same color as the text), deemphasize the text within the webpage, deactivate hyperlinks corresponding to the text, and/or the like.

In yet another embodiment, the spoiler filter 109 may alter or otherwise modify any portions of a broadcast media program content being streamed from the media device 108 that are identified as being likely to include a spoiler with respect to a recorded media program on the DVR 110. In this regard, the spoiler filter 109 may parse or otherwise analyze the streamed media content (e.g., by scanning the closed-captioning, performing image processing, or the like) to identify portions with the streamed media content that match or otherwise satisfy filtering criteria corresponding to a recorded media program on the user's DVR 110 or a media program scheduled for recording on the user's DVR 110. For example, if the user has recorded (or is recording) a broadcast of a sporting event to the DVR 110 and the user is currently streaming a broadcast news media program from the broadcast source 112 to the client device 104 via the peer-to-peer connection 180, the spoiler filter 109 may identify information pertaining to that sporting event contained within a news ticker, closed-captioning text, or the like, and alter or otherwise modify the streamed broadcast news media program content to interfere with the normal presentation of the information pertaining to the sporting event before providing the altered streamed broadcast news media program content to the media player application 107 for presentation on the client device 104. In an alternative embodiment, the spoiler filter 109 may signal, indicate or otherwise notify the media player application 107 to pause presentation of the streamed media program and generate or otherwise provide a notification on the client device 104 that identifies the streaming media program content contains a potential spoiler with respect to a particular media program. In response to receiving an indication that the user would like to proceed with viewing the streaming media program, the spoiler filter 109 may signal, indicate or otherwise notify the media player application 107 to resume presentation of the streaming media program.

FIG. 3 depicts a sequence 300 of communications within the system 100 of FIG. 1 in conjunction with the spoiler mitigation process 200 of FIG. 2 in accordance with one or more exemplary embodiments. In this regard, FIG. 3 illustrates the scenario where the filtering criteria implemented by the spoiler filter 109 are automatically identified based on the recorded media programs stored on the DVR 110 of the media device 108 associated with the user. The illustrated sequence 300 begins with the user manipulating or otherwise operating the client application 105 on the client device 104 to contact 302 the server 102, for example, by inputting a URL or other address associated with the server 102 and/or the portal application 138. After the user is successfully authenticated by the portal application 138, the server 102 and/or portal application 138 identifies the media device 108 associated with the user and communicates 304 with the media device 108 to obtain information about programming stored at the media device 108. For example, the server 102 and/or portal application 138 may transmit or otherwise provide a request for a listing of the media programs stored at the media device 108, and in response to the request, the media device 108 and/or the control module 146 transmits or otherwise provides a list of the recorded media programs stored on the DVR 110. In this regard, the server 102 may download or otherwise obtain, via the network 106, media data objects corresponding to the media programs stored at the media device 108 and/or DVR 110, and stores or otherwise maintains (e.g., in memory 132) the downloaded media data objects to create a local representation of the stored media programs on the media device 108 and/or DVR 110.

In one or more embodiments, the spoiler filter 109 receives 306 the listing of recorded media programs on the DVR 110 from the server 102 and/or the portal application 138 and automatically determines filtering criteria based on the recorded media programs on the DVR 110. For example, the spoiler filter 109 may automatically set or otherwise configure one or more filtering criterions implemented by the spoiler filter 109 to correspond to the titles and/or other metadata of the recorded media programs. As described above, the spoiler filter 109 may also obtain a listing of scheduled media program recordings for the DVR 110 from the server 102 and/or the portal application 138 and determine one or more filtering criteria corresponding to media programs that are scheduled to be recorded to the DVR 110. In alternative embodiments, the server 102 and/or the portal application 138 may determine filtering criteria based on the recorded media programs and transmit or otherwise provide the filtering criteria to the spoiler filter 109.

After the filtering criteria for the spoiler filter 109 are configured, the user may manipulate or otherwise operate the client application 105 to transmit or otherwise provide 308, via the network 106, a request for content to a third-party content source 126, for example, by inputting a URL or other network address associated with a resource on third-party website. In the illustrated embodiment, the third-party content source 126 responds to the request by transmitting or otherwise providing content to the client device 104 via the network 106. The spoiler filter 109 intercepts or otherwise obtains 310 the third-party content received at the client device 104 and applies the filtering criteria corresponding to the recorded (or scheduled to be recorded) media programs on the DVR 110 to the received content. In this regard, the spoiler filter 109 parses, scans, or otherwise analyzes the third-party content for portions that match or otherwise satisfy one or more filtering criterions implemented by the spoiler filter 109. When the spoiler filter 109 identifies a portion of the received third-party content that matches a filtering criterion, the spoiler filter 109 performs one or more remedial actions with respect to that portion of received content corresponding to a potential spoiler. In one or more embodiments, the spoiler filter 109 modifies or alters the presentation of that portion of the received content in a manner that mitigates the potential spoiler, resulting in a filtered version of the received content that is provided 312 to the client application 105 for presentation on the display associated with the client device 104. For example, the spoiler filter 109 may delete or otherwise remove the identified portion of content, or otherwise alter the presentation of the identified portion of content to reduce visibility when presented on the client device 104. In some embodiments, when the identified portion of content corresponds to a hyperlink to additional third-party content, the spoiler filter 109 may disable or otherwise deactivate the hyperlink to reduce the likelihood of the user inadvertently retrieving and viewing content that is likely to contain a potential spoiler. In such embodiments, the user may be able to manipulate the client device 104 to override the spoiler filter 109 and reactivate or enable the hyperlinks within the client application 105.

In another embodiment, the spoiler filter 109 generates or otherwise provides a graphical user interface element (e.g., a pop-up window, a button, or the like) that overlies or otherwise masks the potential spoiler within the received content when presented by client application 105 on the client device 104. In response to the user manipulating or otherwise operating the client device 104 to provide indication that the user acknowledges the potential spoiler, the spoiler filter 109 removes the graphical user interface element, thereby allowing the potential spoiler to be presented by the client application 105 unobstructed. In an alternative embodiment, the spoiler filter 109 may generate or otherwise provide a graphical user interface that indicates the presence of a potential spoiler within the received third-party content and requests acknowledgment by the user of the client device 104 before providing the unaltered third-party content to the client application 105 for presentation. In this regard, in response to the user manipulating or otherwise operating the client device 104 to provide indication that the user acknowledges the potential spoiler within the received content, the spoiler filter 109 provides 312 the unaltered third-party content to the client application 105 for presentation.

It should be noted that the filtering criteria implemented by the spoiler filter 109 may be dynamically adjusted in response to changes to the user's DVR 110. For example, upon a recorded media program being removed from the user's DVR 110, the filtering criteria corresponding to that recorded media program may be automatically discarded by the spoiler filter 109 (e.g., in response to receiving an updated listing of recorded media programs on the DVR 110 from the server 102 and/or portal application 138 that does not include that media program). Likewise, if a scheduled recording for the DVR 110 is canceled, any filtering criteria corresponding to that media program may also be discarded. Conversely, as additional media programs are recorded to the user's DVR 110 and/or scheduled for recording, the filtering criteria implemented by the spoiler filter 109 may be automatically updated to include filtering criteria corresponding to those additional media programs.

FIG. 4 depicts another sequence 400 of communications within the system 100 of FIG. 1 in conjunction with the spoiler mitigation process 200 of FIG. 2 in accordance with one or more exemplary embodiments. In this regard, FIG. 4 illustrates the scenario where the filtering criteria implemented by the spoiler filter 109 are automatically identified based on a media program currently being streamed (or a previously streamed media program) from the media device 108 to the client device 104. The illustrated sequence 400 begins with the user manipulating the client application 105 to transmit or otherwise provide 402 a request to placeshift a particular media program to the server 102 and/or the portal application 138. For example, the portal application 138 may access the program guide 122 and provide a graphical user interface within the client application 105 that includes a listing of the media programs currently being broadcast and available from the broadcast source 112. Thereafter, the user manipulates the client device 104 to select or otherwise indicate a broadcast media program that the user would like to view from within the graphical user interface. In response to receiving the placeshifting request that identifies the selected broadcast media program, the server 102 transmits or otherwise provides 404 streaming instructions to the media device 108 that identify the client device 104 as the destination device for the placeshifting session along with the selected broadcast media program for the placeshifting session. In response to the streaming instructions, the media device 108 automatically initiates the peer-to-peer connection 180 over the network 106 with the client 104. After communicating 406 with the client device 104 to establish the peer-to-peer connection 180, the media device 108 receives or otherwise obtains 408 the selected broadcast media program from the broadcast source 112 (e.g., by tuning the receiver 142 to a broadcast channel identified by the streaming instructions) and automatically transfers or streams 410 the selected broadcast media program to the media player 107 within the client application 105 on the client 104.

In response to the placeshifting session being established between the media device 108 and the media player 107, the spoiler filter 109 identifies or otherwise obtains, from the client application 105 and/or the media player application 107, one or more program identifiers or other metadata associated with the broadcast media program being streamed to the client device 104. Thereafter, the spoiler filter 109 may set or otherwise configure one or more filtering criterions to correspond to the streamed media program to reduce the likelihood of the user encountering spoilers pertaining to that media program. For example, the user may pause or otherwise stop presentation of the streamed media program and manipulate or otherwise operate the client application 105 to transmit or otherwise provide 412, via the network 106, a request for content to a third-party content source 126 (e.g., a third-party website). The third-party content source 126 responds to the request by transmitting or otherwise providing content to the client device 104 via the network 106, and the spoiler filter 109 intercepts or otherwise obtains 414 the third-party content and applies the filtering criteria corresponding to the streamed media program to the received content.

When the spoiler filter 109 identifies a portion of the received third-party content that matches or otherwise satisfies a filtering criterion corresponding to the streamed media program, the spoiler filter 109 performs one or more remedial actions with respect to that identified portion of received content in a similar manner as described above in the context of FIGS. 1-3. For example, in the illustrated embodiment, the spoiler filter 109 modifies or alters the presentation of that portion of the received content in a manner that mitigates the potential spoiler, resulting in a filtered version of the received content that is provided 416 to the client application 105 for presentation on the display associated with the client device 104. In this manner, if the user concurrently browses the Internet while streaming the media program, the spoiler filter 109 may reduce the likelihood of the user inadvertently encountering spoilers with respect to the media program currently being streamed to the client device 104. Additionally, the spoiler filter 109 may store or otherwise maintain the filtering criteria corresponding to a currently (or previously) streamed media program to continually protect the user from inadvertently encountering spoilers with respect to that media program. For example, if the user streams a rebroadcast of an old episode of a particular series, the spoiler filter 109 may continually apply filtering criteria corresponding to that particular series to reduce the likelihood of the user inadvertently encountering spoilers with respect to subsequent and/or future episodes of that particular series based on the user's previous interest in that series.

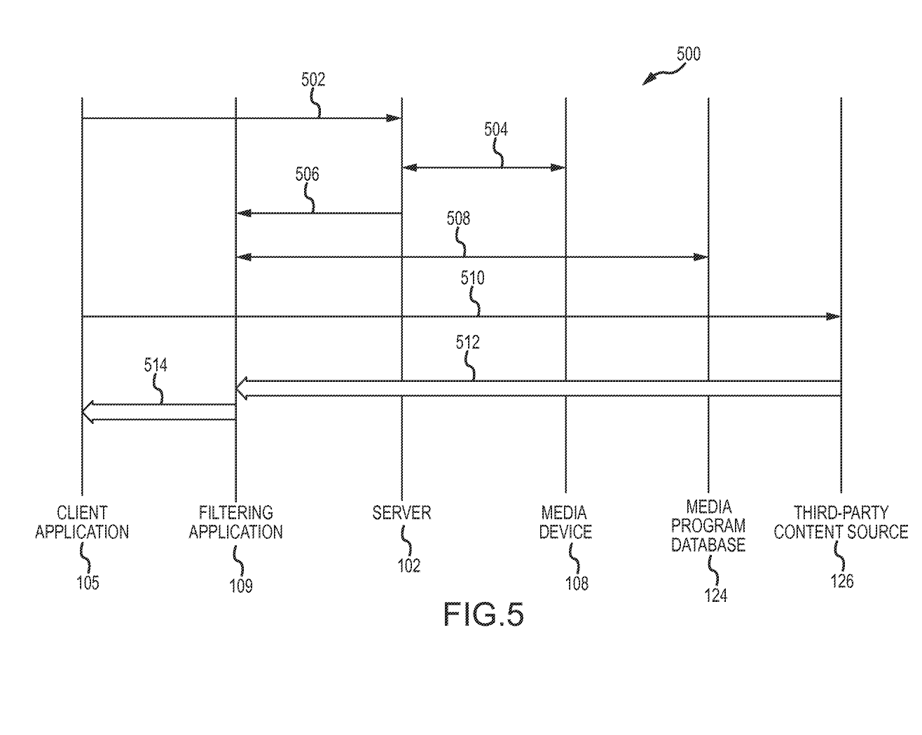

FIG. 5 depicts another sequence 500 of communications within the system 100 of FIG. 1 in conjunction with the spoiler mitigation process 200 of FIG. 2 in accordance with one or more exemplary embodiments. In this regard, FIG. 5 illustrates the scenario where supplemental metadata or other descriptive information is obtained from the media program database 124 and utilized as filtering criteria implemented by the spoiler filter 109. In a similar manner as described above in the context of FIG. 3, the illustrated sequence 500 depicts the client application 105 contacting 502 the server 102 and/or the portal application 138, and the server 102 and/or portal application 138 communicating 504 with the media device 108 to obtain the listing of the media programs stored on the DVR 110. The spoiler filter 109 receives 506 the listing of recorded media programs on the DVR 110 from the server 102 and/or the portal application 138 and automatically determines filtering criteria corresponding to the recorded media programs on the DVR 110. In the illustrated embodiment, the spoiler filter 109 utilizes the program identifiers for the recorded media programs to transmit or otherwise provide 508, via the network 106, a request for supplemental metadata for the recorded media programs from the media program database 124. After retrieving supplemental metadata for a recorded media program from the database 124, the spoiler filter 109 sets or otherwise configures one or more filtering criterions implemented by the spoiler filter 109 to correspond to the supplemental metadata. Although not illustrated in FIG. 5, in alternative embodiments, the server 102 and/or the portal application 138 may utilize the program identifiers for the recorded media programs to obtain supplemental metadata from the media program database 124, determine filtering criteria corresponding to the recorded media programs using the supplemental metadata, and transmit or otherwise provide the filtering criteria to the spoiler filter 109.

In a similar manner as described above in the context of FIGS. 1-4, after the filtering criteria for the spoiler filter 109 are configured, the user may manipulate or otherwise operate the client application 105 to transmit 510, via the network 106, a request for content to a third-party content source 126. The spoiler filter 109 intercepts or otherwise obtains 512 the third-party content and applies the filtering criteria to the received content. In this regard, when the spoiler filter 109 identifies a portion of the received third-party content that matches a filtering criterion corresponding to the supplemental metadata retrieved from the media program database 124, the spoiler filter 109 performs one or more remedial actions with respect to that portion of received content corresponding to a potential spoiler. For example, the spoiler filter 109 may provide 514 a filtered version of the received third-party content to the client application 105 for presentation on the display associated with the client device 104. In this manner, the supplemental metadata retrieved from the media program database 124 may augment the filtering criteria identified based on the listing of stored media programs on the DVR 110 obtained from the server 102 and/or the portal application 138. For example, if the broadcast of a particular noteworthy event (e.g., a sporting event, entertainment awards presentation, or the like) is stored on the DVR 110, supplemental metadata obtained from the media program database 124 (e.g., names of individuals involved in and/or associated with the media program, genre information, or the like) the may be utilized to identify and filter content that may contain potential spoilers that would not otherwise be identified based solely on the title, program identifiers, and/or other descriptive information contained in the listing of media programs on the DVR 110.

FIG. 6 depicts another sequence 600 of communications within the system 100 of FIG. 1 in conjunction with the spoiler mitigation process 200 of FIG. 2 in accordance with one or more exemplary embodiments. In this regard, FIG. 6 illustrates the scenario where the spoiler filter 109 affects the presentation of currently broadcast media programs that may contain potential spoilers within a program guide graphical user interface presented by the portal application 138 within the client application 105. In a similar manner as described above in the context of FIGS. 3 and 5, the illustrated sequence 600 depicts the client application 105 contacting 602 the server 102 and/or the portal application 138, and the server 102 and/or portal application 138 communicating 604 with the media device 108 to obtain the listing of the media programs stored on the user's DVR 110. The illustrated sequence 600 continues with the spoiler filter 109 receiving 606 the listing of recorded media programs on the DVR 110 from the server 102 and/or the portal application 138, obtaining 608 supplemental metadata for the recorded media programs from the media program database 124, and identifying or otherwise determining filtering criteria corresponding to the recorded media programs on the DVR 110.

In the illustrated embodiment, the sequence 600 continues with the user manipulating the client application 105 to transmit or otherwise provide 610 a request for a program guide to the server 102 and/or the portal application 138. In response, the server 102 and/or the portal application 138 accesses 612 the program guide 122, generates a graphical user interface that includes a listing of the media programs currently being broadcast and available from the broadcast source 112, and transmits or otherwise provides 614 the program guide graphical user interface to the client device 104. The spoiler filter 109 intercepts or otherwise obtains 614 the program guide content and applies the filtering criteria. When the spoiler filter 109 identifies current broadcast media programs that match a filtering criterion implemented by the spoiler filter 109, the spoiler filter 109 performs one or more remedial actions with respect to those media programs within the program guide graphical user interface. For example, the spoiler filter 109 may disable or otherwise deactivate the graphical user interface elements, hyperlinks, or the like corresponding to the current broadcast media programs that may contain potential spoilers to reduce the likelihood of the user inadvertently placeshifting a current broadcast media program that is likely to contain a potential spoiler with respect to a recorded media program on the DVR 110. Alternatively, the spoiler filter 109 may adjust or otherwise modify the presentation of the broadcast media programs that may contain potential spoilers within the program guide graphical user interface. Additionally, the spoiler filter 109 may delete, remove, or otherwise modify the visibility of potential spoilers within the description of a respective broadcast media program. Thereafter, the spoiler filter 109 provides 616 the filtered program guide graphical user interface to the client application 105 for presentation on the client device 104.

In another embodiment, the spoiler filter 109 may provide 616 the unaltered program guide graphical user interface to the client application 105. Thereafter, upon the user selecting a graphical user interface element, hyperlink, or the like to indicate a desire to placeshift a current broadcast media program that may contain a potential spoiler, the spoiler filter 109 may generate or otherwise provide a graphical user interface that indicates the possibility of a potential spoiler within the selected media program and requests acknowledgment by the user of the client device 104. In response to a receiving an indication that the user acknowledges the potential spoiler, the spoiler filter 109 allows the placeshifting request to be provided to the server 102 and/or portal application 138 for placeshifting the selected media program from the broadcast source 112 to the client device 104 via the media device 108.

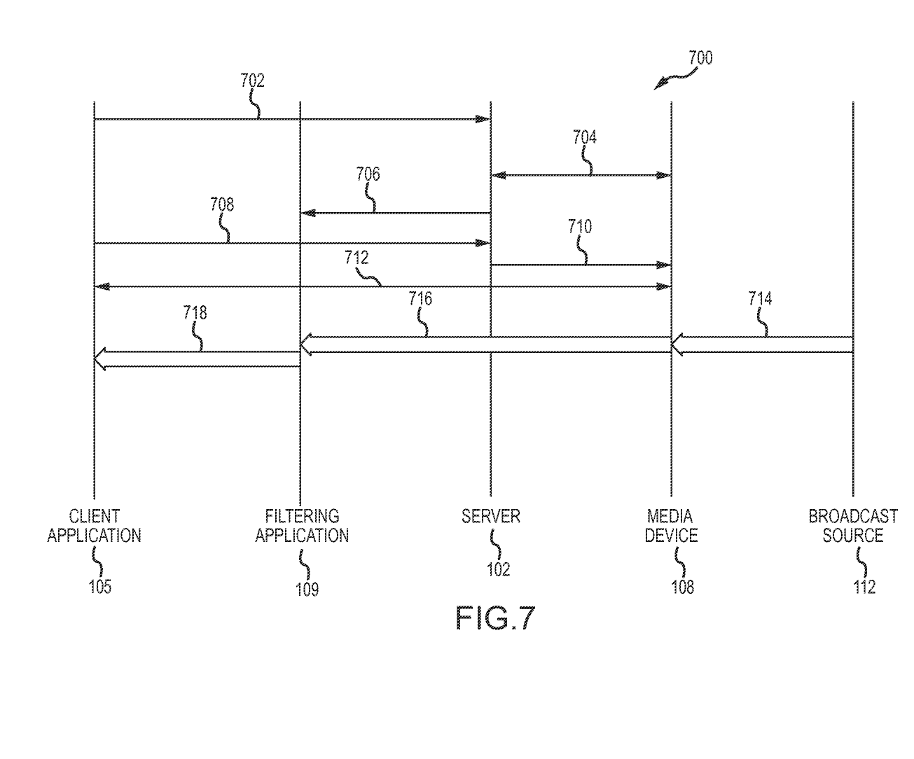

FIG. 7 depicts another sequence 700 of communications within the system 100 of FIG. 1 in conjunction with the spoiler mitigation process 200 of FIG. 2 in accordance with one or more exemplary embodiments. In this regard, FIG. 7 illustrates the scenario where the spoiler filter 109 inhibits spoilers within a broadcast media program currently being streamed from the media device 108 to the client device 104. In a similar manner as described above, the illustrated sequence 700 depicts the client application 105 contacting 702 the server 102 and/or the portal application 138, and the server 102 and/or portal application 138 communicating 704 with the media device 108 to obtain the listing of the media programs stored on the user's DVR 110. The illustrated sequence 700 continues with the spoiler filter 109 receiving 706 the listing of recorded media programs on the DVR 110 from the server 102 and/or the portal application 138, and identifying or otherwise determining filtering criteria corresponding to the recorded media programs and/or scheduled recordings on the DVR 110.

As described above, the user manipulates the client device 104 to select or otherwise indicate a broadcast media program that the user would like to view and transmit 708 a placeshifting request to the server 102 and/or the portal application 138. In response to receiving the placeshifting request, the server 102 transmits or otherwise provides 710 streaming instructions to the media device 108, and in response to the streaming instructions, the media device 108 automatically communicates 712 with the client 104 to establish the peer-to-peer connection 180 over the network 106 with the client 104. Thereafter, the media device 108 receives or otherwise obtains 714 the selected broadcast media program from the broadcast source 112 (e.g., by tuning the receiver 142 to a broadcast channel identified by the streaming instructions) and automatically transfers or streams 716 the selected broadcast media program to the client 104.

In the embodiment of FIG. 7, the spoiler filter 109 functions as an intermediary that intercepts or otherwise obtains the streamed broadcast media program content and parses or otherwise analyzes the streamed media content (e.g., by scanning the closed-captioning, performing image processing, or the like) to identify portions with the streamed broadcast media content that match or otherwise satisfy filtering criteria. For example, if a broadcast of a sporting event is stored on the user's DVR 110 and the streamed broadcast media program includes a news ticker or the like that displays the outcome of the sporting event, the spoiler filter 109 may detect or otherwise identify that portion of the streamed broadcast media program content and remove, mask, block, or otherwise inhibit user's visibility of the outcome of the sporting event. Thereafter, the spoiler filter 109 provides 718 the altered streamed broadcast media program content to the media player application 107 within the client application 105 for presentation on the client device 104. In an alternative embodiment, the spoiler filter 109 may signal, indicate or otherwise notify the media player application 107 to pause presentation of the streamed media program and generate or otherwise provide a notification on the client device 104 that identifies the upcoming portion of the streaming media program content contains a potential spoiler with respect to a particular media program before providing 718 that portion of the streaming media program content to the media player 107 in response to receiving an indication from the user.

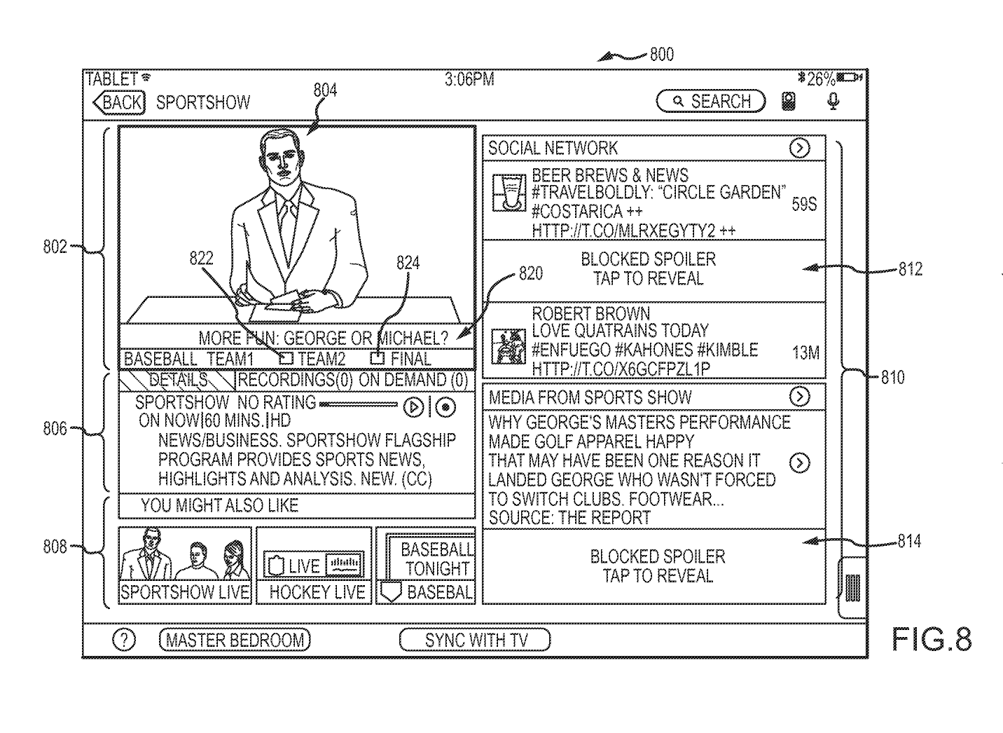

FIG. 8 depicts an exemplary graphical user interface (GUI) display 800 that may be presented that may be presented by the client application 105 and/or the portal application 138 on the client device 104 in conjunction with the spoiler mitigation process 200 of FIG. 2. As described above, a user of the client device 104 accesses the portal application 138, which authenticates the user and allows the user of the client 104 to manipulate a graphical user interface element within the client application 105 to select or otherwise indicate a desire to view or stream a media program from the media device 108 to the client 104. After receiving indication of a desire to stream a media program, the portal application 138 provides streaming instructions to the media device 108 for initiating a placeshifting session and streaming video content 804 corresponding to the media program to a media player 802 (e.g., media player 107) which is embedded or otherwise integrated within the GUI display 800. In the illustrated embodiment, the GUI display 800 also includes a program information region 806 proximate the media player 802, wherein the portal application 138 displays or otherwise presents the metadata and/or descriptive information (e.g., from database 124) that is associated with the video content 804 being viewed in the media player 802 within the program information region 806 concurrently to presentation of the video content 804. Additionally, the portal application 138 may display or otherwise present recommended media programs for the viewer in a recommendation region 808.

The illustrated GUI display 800 also includes a supplemental information region 810 for presenting content obtained from one or more third-party content sources 126, such as a feed provided by a social networking website. The spoiler filter 109 inhibits the presentation of portions 812, 814 of the received content downloaded from the third-party content source 126 that are likely to include a spoiler with respect to a particular media program. As described above, the spoiler filter 109 may parse or otherwise analyze the code for the feed to identify portions 812, 814 feed that match or otherwise satisfy one or more filtering criterions and modify or otherwise alter the code for the feed before providing the modified feed to the client application 105 for presentation within the supplemental information region 810, for example, by modify the visibility of the original text for the identified portions 812, 814 of content and over on the client device 104. For example, in one embodiment, the blocked portions 812, 814 of content correspond to recorded (or scheduled to be recorded) media programs on the user's DVR 110 (e.g., portions of received content including text matching one or more filtering criteria corresponding to a recorded media program). In alternative embodiments, the blocked portions 812, 814 of content correspond to media program 704 currently being streamed to the client 104. Although not illustrated in FIG. 8, in a similar manner, the spoiler filter 109 may parse or otherwise analyze the code for the program information region 806 and/or the recommendation region 808 to block portions of text within those regions 806, 808 that correspond to media programs recorded (or scheduled to be recorded) on the user's DVR 110.

As illustrated in FIG. 8, in some embodiments, the spoiler filter 109 may modify the code for the supplemental information region 810 such that the blocked portions 812, 814 may be selected by the user to indicate a desire to override the spoiler filter 109. In response to receiving indication from a user that the user would like to view blocked content (e.g., by the user selecting a blocked portion 812), the spoiler filter 109 may update the supplemental information region 810 to enable presentation of the original portions of the received content from the third-party content source 126 that matched one or more filtering criterions. In other words, the presentation of the identified portions 812, 814 of the received content may be uninhibited after receiving an indication that the user would like to view those portions 812, 814.

FIG. 8 also depicts the scenario where the spoiler filter 109 alters or otherwise modifies portions of the media program content 804 being streamed from the media device 108 that are identified as being likely to include a spoiler with respect to a recorded media program on the DVR 110. As described above in the context of FIGS. 2 and 7, the spoiler filter 109 may parse or otherwise analyze the streamed media content 804 and identify portions 822, 824 with the streamed media content 804 that match or otherwise satisfy filtering criteria corresponding to a recorded media program on the user's DVR 110. For example, if the user has recorded a broadcast of a sporting event on the user's DVR 110 and the streamed broadcast media program content 804 includes a ticker region 820, the spoiler filter 109 may detect or otherwise identify portions 822, 824 within the ticker region 820 of the streamed broadcast media program content 804 that correspond to the sporting event and remove, mask, block, or otherwise inhibit user's visibility of the ticker portions 822, 824 pertaining to the outcome of that recorded sporting event.

To briefly summarize, by virtue of the subject matter described herein, the likelihood of a user inadvertently encountering spoilers pertaining to a media program is reduced, thereby mitigating any potential effects of the spoilers and preserving the user's enjoyment of that media program. The filtering criteria utilized to detect and inhibit spoilers may be automatically identified based on media programs recorded to or scheduled to be recorded to a media device associated with the user, and additionally, the filtering criteria may be dynamically updated to automatically reflect the currently recorded media programs or currently scheduled recordings at the media device.

The general systems, structures and techniques described above may be inter-combined, enhanced, modified and/or otherwise implemented to provide any number of different features. In particular, the term “exemplary” is used herein to represent one example, instance or illustration that may have any number of alternates. Any implementation described herein as “exemplary” should not necessarily be construed as preferred or advantageous over other implementations.

For the sake of brevity, conventional techniques related to placeshifting, streaming media, networking, content filtering algorithms or other techniques for analyzing content, and other functional aspects of the systems (and the individual operating components of the systems) may not be described in detail herein. The subject matter may be described herein in terms of functional and/or logical block components, and with reference to symbolic representations of operations, processing tasks, and functions that may be performed by various computing components or devices. It should be appreciated that in alternative embodiments the various block components shown in the figures may be equivalently realized by any number of hardware, software, and/or firmware components configured to perform the specified functions. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter. In addition, certain terminology may also be used herein for the purpose of reference only, and thus is not intended to be limiting. For example, terms such as “first,” “second” and other such numerical terms referring to structures do not imply a sequence or order unless clearly indicated by the context.

While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents. Accordingly, details of the exemplary embodiments or other limitations described above should not be read into the claims absent a clear intention to the contrary.

What is claimed is:

1. A method of mitigating spoilers, the method comprising:
identifying a filtering criterion based on a media program available for viewing on a client device via a network;
obtaining, via the network, content for presentation on the client device;
identifying a portion of the content corresponding to the media program using the filtering criterion; and
inhibiting presentation of the identified portion of the content on the client device.

2. The method of claim 1, further comprising identifying a recorded media program stored on a media device coupled to the network, wherein the filtering criterion corresponds to the recorded media program.

3. The method of claim 2, wherein identifying the recorded media program comprises obtaining, by the client device from a server via the network, a listing of media programs stored on the media device, the listing of media programs including the recorded media program, wherein the server obtains the listing of media programs from the media device via the network.

4. The method of claim 1, further comprising identifying a scheduled recording for a media device associated with a user of the client device, wherein the filtering criterion corresponds to the media program associated with the scheduled recording.

5. The method of claim 1, further comprising the client device streaming the media program from a media device via the network, wherein identifying the filtering criterion comprises identifying the filtering criterion corresponding to the media program in response to the streaming.

6. The method of claim 1, wherein inhibiting presentation of the identified portion comprises removing the identified portion from within the content prior to presenting the content on the client device, resulting in a filtered version of the content presented on the client device.

7. The method of claim 1, wherein inhibiting presentation of the identified portion comprises deactivating the identified portion within the content prior to presenting the content on the client device.

8. The method of claim 1, wherein inhibiting presentation of the identified portion comprises providing a notification on the client device prior to presenting the identified portion of content on the client device.

9. The method of claim 1, wherein identifying the filtering criterion based on the identified media program comprises obtaining metadata associated with the identified media program, the filtering criterion comprising the metadata.

10. The method of claim 1, further comprising identifying availability of the media program at a media device coupled to the network prior to identifying the filtering criterion, wherein identifying the filtering criterion comprises identifying the filtering criterion corresponding to the media program available at the media device for placeshifting to the client device via the network.

11. A computer-readable medium having computer-executable instructions stored thereon that, when executed by a processing system of the client device, cause the processing system to perform the method of claim 1.

12. A method of mitigating spoilers, the method comprising:
identifying a recorded media program available for placeshifting from a media device to a client device via a network;
identifying a filtering criterion corresponding to the recorded media program;
receiving, at the client device via the network, content for presentation on the client device;
applying the filtering criterion to the received content using the filtering criterion to identify a portion of the received content matching the filtering criterion; and
inhibiting presentation of the identified portion of the received content on the client device.

13. The method of claim 12, the content comprising a web page, wherein inhibiting presentation of the identified portion comprises removing the identified portion from within the web page prior to presenting the web page on the client device.

14. The method of claim 12, the content comprising a web page, the portion of the received content matching the filtering criterion comprising a hyperlink within the web page, wherein inhibiting presentation of the identified portion comprises deactivating the hyperlink within the web page.

15. The method of claim 12, the content comprising a web page, wherein inhibiting presentation of the identified portion comprises:
providing, on the client device, a graphical user interface including a notification of the identified portion matching the filtering criterion prior to presenting the web page on the client device;
receiving, via the graphical user interface, a user input indicative of a desire to proceed with presentation of the web page; and
presenting the web page on the client device in response to receiving the user input.

16. The method of claim 12, wherein identifying the filtering criterion based on the identified media program comprises:
obtaining, from a database via the network, metadata associated with the media program; and
determining the filtering criterion based on the metadata.

17. The method of claim 12, wherein identifying the recorded media program comprises obtaining, by the client device from a server via the network, a listing of media programs stored on the media device, the listing of media programs including the recorded media program.

18. The method of claim 17, the media device comprising a set-top box coupled to the network, the method further comprising the server obtaining the listing of media programs stored on the set-top box from the set-top box via the network.

19. A computer-readable medium comprising computer-executable instructions that, when executed by a processing system, cause the processing system to:
identify a media program available from a media device for viewing via a network;
identify filtering criteria corresponding to the media program;
receive, via the network, content for presentation;
apply the filtering criteria to the received content to identify a portion of the received content that satisfies the filtering criteria; and
interfere with presentation of the identified portion of the received content.

20. The computer-readable medium of claim 19, wherein the computer-executable instructions cause the processing system to identify the media program by obtaining, from a server via the network, a listing of media programs available at the media device.
